(19) United States
(12) Patent Application Publication
(10) Pub. No.: US 2023/0076400 A1
(43) Pub. Date: Mar. 9, 2023

(54) INVERSE ELEMENT OPERATION APPARATUS AND COMPUTER READABLE MEDIUM

(71) Applicant: Mitsubishi Electric Corporation, Tokyo (JP)

(72) Inventor: Kenichiro HAYASAKA, Tokyo (JP)

(73) Assignee: Mitsubishi Electric Corporation, Tokyo (JP)

(21) Appl. No.: 17/987,977

(22) Filed: Nov. 16, 2022

Related U.S. Application Data
(63) Continuation of application No. PCT/JP2020/026860, filed on Jul. 9, 2020.

(51) Int. Cl. G06F 7/552; G06F 7/523; G06F 7/50

(52) U.S. Cl. CPC G06F 7/552; G06F 7/523; G06F 7/50

(57) ABSTRACT

An acceptance unit (110) accepts an element a. A preliminary operation unit (120) calculates t₁ that is a computation result of a₀², t₂ that is a computation result of a₂², t₃ that is a computation result of a₀a₁, t₄ that is a computation result of a₁a₂, and t₇ that is equal to a computation result of (a₀+a₁)(a₁−a₂), using a₀, a₁, and a₂. An inverse element operation unit (130) calculates b₀ that is equal to a computation result of a₀²−a₁a₂v, b₁ that is equal to a computation result of a₂²v−a₀a₁, and b₂ that is equal to a computation result of a₁²−a₀a₂, using t₁, t₂, t₃, t₄, and t₇. An output unit (140) generates and outputs an inverse element a⁻¹, using b₀, b₁, and b₂.

### CROSS REFERENCE TO RELATED APPLICATIONS

This application is a Continuation of PCT International Application No. PCT/JP2020/026860, filed on Jul. 9, 2020, which is hereby expressly incorporated by reference into the present application.

### TECHNICAL FIELD

The present disclosure relates to a technique that enables a fast multiplicative inverse element calculation in a subgroup of a finite field.

### BACKGROUND ART

There are cryptographic algorithms that utilize operations on a finite field.

There may be a case in which by utilizing the properties of a subgroup of a finite field, the amount of computation for operations can be reduced, and as a result, a cryptographic algorithm can be made more efficient.

Pairing-based cryptography realizes various highly convenient functions by utilizing the properties of a pairing map which are bilinearity and non-degeneracy.

Computation of a pairing map is composed of operations on a finite field. Therefore, speeding up operations on a finite field is important in making pairing-based cryptography more efficient.

It is known that in Ate pairing or optimal Ate pairing, which are computation algorithms for pairing maps, an inverse element calculation and a squaring can be computed faster by utilizing the properties of a subgroup of a finite field, so that pairing-based cryptography can be made more efficient.

Computation of a pairing map requires an inverse element calculation as described below.

For a prime field Fₚ, extension fields (Fₚⁿ, Fₚ^{k}) as described below will be considered. Each of the extension field Fₚⁿ and the extension field Fₚ^{k} is the extension field of the prime field Fₚ. Each of the prime field Fₚ, the extension field Fₚⁿ, and the extension field Fₚ^{k} is a finite field.

Fₚⁿ=Fₚ[v]/(vⁿ−α),

Fₚ^{k}=Fₚⁿ[w]/(w³−v).

“k” is the smallest integer that satisfies r|(p^{k}−1) for a prime number r and a prime number p. “k” satisfies k=3n for an integer n.

“α” is an element of the prime field Fₚ.

“v” is an element of the extension field Fₚⁿ that satisfies f(v)=0 for a polynomial f(X)=Xⁿ−α that is irreducible on the prime field Fₚ.

“w” is an element of the extension field Fₚ^{k} that satisfies g(w)=0 for a polynomial g(X)=X³−v that is irreducible on the extension field Fₚⁿ.

A set of elements of the extension field Fₚ^{k} of order Φ3(pⁿ) is called a cyclotomic subgroup. This set is denoted as GΦ3(pⁿ). Note that Φm(x) means an m-th cyclotomic polynomial.

The element a of the set GΦ3(pⁿ) is expressed by the following formula. Each of “a₀”, “a₁”, and “a₂” is an element of the extension field Fₚⁿ.

a=a₀+a₁w+a₂w²

In this case, an inverse element a⁻¹ of the element a of the set GΦ3(pⁿ) can be calculated by two Frobenius operations and one multiplication on the extension field Fₚ^{k}.

This indicates that an inverse element calculation on the set GΦ3(pⁿ) can be computed faster than an inverse element calculation on the extension field Fₚ^{k}.

Non-Patent Literature 1 indicates that an inverse element calculation on the set GΦ3(pⁿ) is possible when “k=27”.

Furthermore, the inverse element a⁻¹ is expressed by the following formula.

a⁻¹=(a₀²−a₁a₂v)+(a₂²v−a₀a₁)w+(a₁²−a₀a₂)w²

This formula includes three multiplications (a₁a₂, a₀a₁, a₀a₂) and three squarings (a₀², a₂², a₁²) on the extension field Fₚⁿ.

Non-Patent Literature 2 indicates that an inverse element calculation by this formula is possible when “k=9, 15, 27”.

### CITATION LIST

### Non-Patent Literature

Non-Patent Literature 1: X. Zhang and D. Lin, “Analysis of Optimum Pairing Products at High Security Levels,” INDOCRYPT 2012, LNCS 7668, pp. 412-430, 2012.
Non-Patent Literature 2: E. Fouotsa, N. El Mrabet and A. Pecha “Computing Optimal Ate Pairing on Elliptic Curves with Embedding Degree 9, 15 and 27,” IACR Cryptology ePrint Archive, 2016/1187, 2016.

### SUMMARY OF INVENTION

### Technical Problem

An inverse element calculation for a pairing map requires operations on a finite field, and the operations on the finite field are a bottleneck in making pairing-based cryptography more efficient.

In particular, multiplications and squarings among the operations on the finite field involve a large amount of computation in comparison with additions, subtractions, and fractional multiplications (½ multiplication, ¼ multiplication, etc.).

An object of the present disclosure is to make it possible to reduce the amount of computation for an inverse element calculation for a pairing map.

### Solution to Problem

An inverse element operation apparatus of the present disclosure calculates an inverse element a⁻¹ of an element a.

The element a is expressed by a=a₀+a₁w+a₂w².

The inverse element a⁻¹ is expressed by a⁻¹=(a₀²−a₁a₂v)+(a₂²v−a₀a₁)w+(a₁²−a₀a₂)w².

The inverse element operation apparatus includes

an acceptance unit to accept the element a;

a preliminary operation unit to calculate t₁ that is a computation result of a₀², t₂ that is a computation result of a₂², t₃ that is a computation result of a₀a₁, t₄ that is a computation result of a₁a₂, and t₇ that is equal to a computation result of (a₀+a₁)(a₁−a₂), using a₀, a₁, and a₂;

an inverse element operation unit to calculate b₀ that is equal to a computation result of a₀²−a₁a₂v, b₁ that is equal to a computation result of a₂²v−a₀a₁, and b₂ that is equal to a computation result of a₁²−a₀a₂, using t₁, t₂, t₃, t₄, and t₇; and

an output unit to generate and output the inverse element a⁻¹, using b₀, b₁, and b₂.

### Advantageous Effects of Invention

According to the present disclosure, squarings on a finite field for calculating an inverse element a⁻¹ can be reduced from three times to twice. That is, the amount of computation required for an inverse element calculation for a pairing map can be reduced. As a result, pairing-based cryptography can be made more efficient.

### BRIEF DESCRIPTION OF DRAWINGS

FIG. 1 is a configuration diagram of an inverse element operation apparatus 100 in a first embodiment;

FIG. 2 is a configuration diagram of a preliminary operation unit 120 in the first embodiment;

FIG. 3 is a configuration diagram of an inverse element operation unit 130 in the first embodiment;

FIG. 4 is a flowchart of an inverse element operation method in the first embodiment;

FIG. 5 is a flowchart of a preliminary operation process (S120) in the first embodiment;

FIG. 6 is a flowchart of an inverse element operation process (S130) in the first embodiment;

FIG. 7 is a hardware configuration diagram of the inverse element operation apparatus 100 in the first embodiment;

FIG. 8 is a configuration diagram of an inverse element operation apparatus 200 in a second embodiment;

FIG. 9 is a configuration diagram of a preliminary operation unit 220 in the second embodiment;

FIG. 10 is a configuration diagram of an inverse element operation unit 230 in the second embodiment;

FIG. 11 is a flowchart of an inverse element operation method in the second embodiment;

FIG. 12 is a flowchart of a preliminary operation process (S220) in the second embodiment;

FIG. 13 is a flowchart of an inverse element operation process (S230) in the second embodiment; and

FIG. 14 is a hardware configuration diagram of the inverse element operation apparatus 200 in the second embodiment.

### DESCRIPTION OF EMBODIMENTS

In the embodiments and drawings, the same elements or corresponding elements are denoted by the same reference sign. Description of an element denoted by the same reference sign as that of an element that has been described will be omitted or simplified as appropriate. Arrows in diagrams mainly indicate flows of data or flows of processing.

### First Embodiment

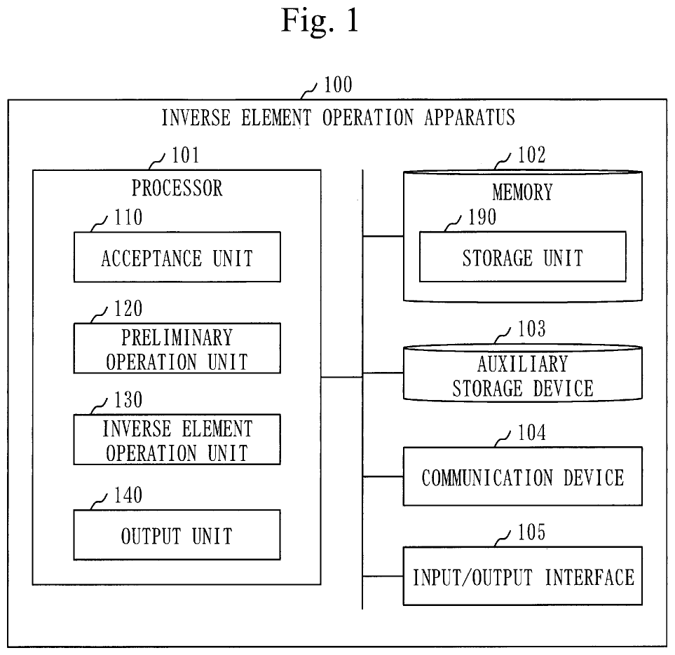

An embodiment in which an inverse element a⁻¹ of an element a of a cyclotomic subgroup is calculated will be described based on FIGS. 1 to 7.

*** Description of Configuration ***

Based on FIG. 1, a configuration of an inverse element operation apparatus 100 will be described.

The inverse element operation apparatus 100 is a computer that includes hardware such as a processor 101, a memory 102, an auxiliary storage device 103, a communication device 104, and an input/output interface 105. These hardware components are connected with one another through signal lines.

The processor 101 is an IC that performs operational processing and controls other hardware components. For example, the processor 101 is a CPU.

IC is an abbreviation for Integrated Circuit.

CPU is an abbreviation for Central Processing Unit.

The memory 102 is a volatile or non-volatile storage device. The memory 102 is also called a main storage device or a main memory. For example, the memory 102 is a RAM. Data stored in the memory 102 is saved in the auxiliary storage device 103 as necessary.

RAM is an abbreviation for Random Access Memory.

The auxiliary storage device 103 is anon-volatile storage device. For example, the auxiliary storage device 103 is a ROM, an HDD, or a flash memory. Data stored in the auxiliary storage device 103 is loaded into the memory 102 as necessary.

ROM is an abbreviation for Read Only Memory.

HDD is an abbreviation for Hard Disk Drive.

The communication device 104 is a receiver and a transmitter. For example, the communication device 104 is a communication chip or a NIC.

NIC is an abbreviation for Network Interface Card.

The input/output interface 105 is a port to which an input device and an output device are connected. For example, the input/output interface 105 is a USB terminal, the input device is a keyboard and a mouse, and the output device is a display.

USB is an abbreviation for Universal Serial Bus.

The inverse element operation apparatus 100 includes elements such as an acceptance unit 110, a preliminary operation unit 120, an inverse element operation unit 130, and an output unit 140. These elements are realized by software.

The auxiliary storage device 103 stores an inverse element operation program to cause a computer to function as the acceptance unit 110, the preliminary operation unit 120, the inverse element operation unit 130, and the output unit 140. The inverse element operation program is loaded into the memory 102 and executed by the processor 101.

The auxiliary storage device 103 further stores an OS. At least part of the OS is loaded into the memory 102 and executed by the processor 101.

The processor 101 executes the inverse element operation program while executing the OS.

OS is an abbreviation for Operating System.

Input data and output data of the inverse element operation program are stored in a storage unit 190.

The memory 102 functions as the storage unit 190. However, a storage device such as the auxiliary storage device 103, a register in the processor 101, and a cache memory in the processor 101 may function as the storage unit 190 in place of the memory 102 or together with the memory 102.

The inverse element operation apparatus 100 may include a plurality of processors as an alternative to the processor 101.

The inverse element operation program can be recorded (stored) in a computer readable format in a non-volatile recording medium such as an optical disc or a flash memory.

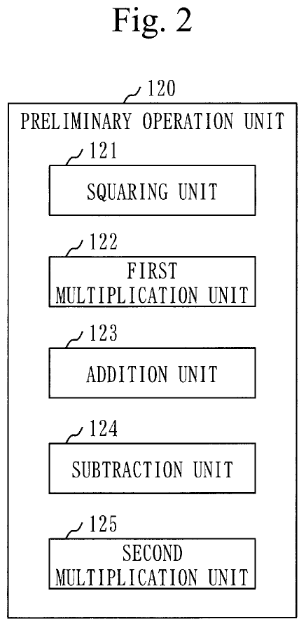

Based on FIG. 2, a configuration of the preliminary operation unit 120 will be described.

The preliminary operation unit 120 includes elements such as a squaring unit 121, a first multiplication unit 122, an addition unit 123, a subtraction unit 124, and a second multiplication unit 125. The functions of these elements will be described later.

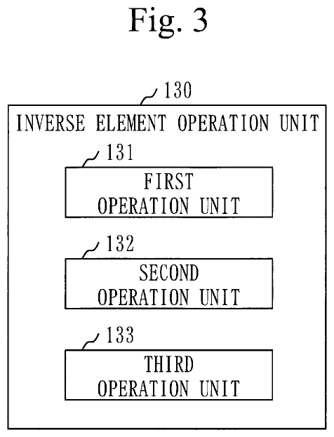

Based on FIG. 3, a configuration of the inverse element operation unit 130 will be described.

The inverse element operation unit 130 includes elements such as a first operation unit 131, a second operation unit 132, and a third operation unit 133. The functions of these elements will be described later.

*** Description of Preliminary Conditions ***

Preliminary conditions for an inverse element calculation by the inverse element operation apparatus 100 will be described.

“p” is a prime number.

“Fₚ” is a field whose number of elements is p.

“k” and “n” are integers that satisfy k=3n.

Each of “Fₚⁿ” and “Fₚ^{k}” is an extension field of the field Fₚ.

“α” is an element of the field Fₚ.

The extension field Fₚⁿ and the extension field Fₚ^{k} are expressed by the following formulas.

Fₚⁿ=Fₚ[v]/(vⁿ−α),

Fₚ^{k}=Fₚⁿ[w]/(w³−v).

“GΦ3(pⁿ)” is a set of elements of the extension field Fₚ^{k} with order Φ3(pⁿ), and is called a cyclotomic subgroup. Note that Φm(x) is an m-th cyclotomic polynomial.

“α” is an element of the set GΦ3(pⁿ). That is, “a” is the element of the cyclotomic subgroup.

“a⁻¹” is an inverse element of the element a.

Each of “a₀”, “a₁”, and “a₂” is an element of the extension field Fₚⁿ.

The element a is expressed by the following formula.

a=a₀+a₁w+a₂w²∈GΦ3(pⁿ)

The inverse element “a⁻¹” is expressed by the following formula.

a⁻¹=(a₀²−a₁a₂v)+(a₂²v−a₀a₁)w+(a₁²−a₀a₂)w²

*** Description of Operation ***

A procedure for operation of the inverse element operation apparatus 100 is equivalent to an inverse element operation method. The procedure for operation of the inverse element operation apparatus 100 is also equivalent to a procedure for processing by the inverse element operation program.

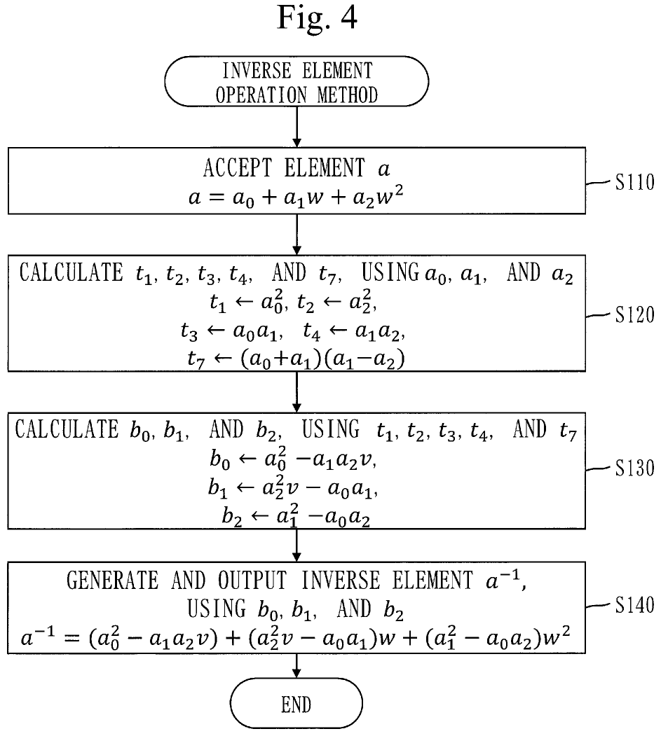

Based on FIG. 4, the inverse element operation method will be described.

In step S110, the acceptance unit 110 accepts an element a.

For example, the element a is transmitted to the inverse element operation apparatus 100 from a pairing mapping apparatus that performs operations of pairing mapping or a pairing-based cryptographic apparatus that performs operations of pairing-based cryptography. Then, the acceptance unit 110 receives the element a.

For example, the element a is input to the inverse element operation apparatus 100 by a user. Then, the acceptance unit 110 accepts the element a that has been input.

The element a includes a₀, a₁, and a₂ and is expressed by the following formula.

a=a₀+a₁w+a₂w²

In step S120, the preliminary operation unit 120 calculates t₁, t₂, t₃, t₄, and t₇, using a₀, a₁, and a₂, where

t₁ is a computation result of a₀²,

t₂ is a computation result of a₂²,

t₃ is a computation result of a₀a₁,

t₄ is a computation result of a₁a₂, and

t₇ is equal to a computation result of (a₀+a₁)(a₁−a₂).

A computation result of X is a value obtained by computing X.

Y that is equal to a computation result of X is the same value as the value obtained by computing X, and is obtained without computing X.

Details of step S120 will be described later.

In step S130, the inverse element operation unit 130 calculates b₀, b₁, and b₂, using t₁, t₂, t₃, t₄, and t₇, where

b₀ is equal to a computation result of a₀²−a₁a₂v,

b₁ is equal to a computation result of a₂²v−a₀a₁, and

b₂ is equal to a computation result of a₁²−a₀a₂.

Details of step S130 will be described later.

In step S140, the output unit 140 outputs an inverse element a⁻¹.

For example, the output unit 140 transmits the inverse element a⁻¹ to the transmission source of the element a. Alternatively, the output unit 140 writes the inverse element a⁻¹ in a recording medium specified by the user.

The inverse element a⁻¹ is the inverse element of the element a and is expressed by the following formula.

a⁻¹=(a₀²−a₁a₂v)+(a₂²v−a₀a₁)w+(a₁²−a₀a₂)w²

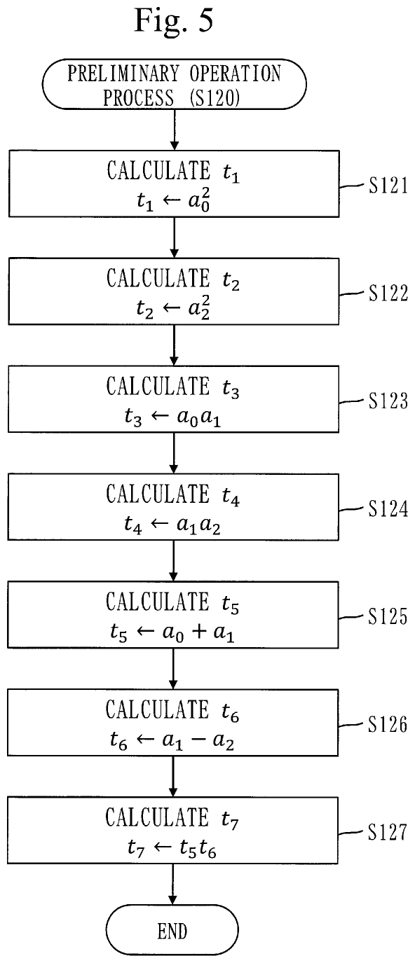

Based on FIG. 5, a preliminary operation process (S120) will be described.

In step S121, the squaring unit 121 performs a squaring using a₀. Specifically, the squaring unit 121 computes a₀². By this, t₁ is calculated.

This t₁ is a computation result of a₀² and is expressed as indicated below.

t₁←a₀²

In step S122, the squaring unit 121 performs a squaring using a₂. Specifically, the squaring unit 121 computes a₂². By this, t₂ is calculated.

This t₂ is a computation result of a₂² and is expressed as indicated below.

t₂←a₂²

In step S123, the first multiplication unit 122 performs a multiplication using a₀ and a₁. Specifically, the first multiplication unit 122 computes a₀a₁. By this, t₃ is calculated.

This t₃ is a computation result of a₀a₁ and is expressed as indicated below.

t₃←a₀a₁

In step S124, the first multiplication unit 122 performs a multiplication using a₁ and a₂. Specifically, the first multiplication unit 122 computes a₁a₂. By this, t₄ is calculated.

This t₄ is a computation result of a₁a₂ and is expressed as indicated below.

t₄←a₁a₂

In step S125, the addition unit 123 performs an addition using a₀ and a₁. Specifically, the addition unit 123 computes a₀+a₁. By this, t₅ is calculated.

This t₅ is a computation result of a₀+a₁ and is expressed as indicated below.

t₅←a₀+a₁

In step S126, the subtraction unit 124 performs a subtraction using a₁ and a₂. Specifically, the subtraction unit 124 computes a₁−a₂. By this, t₆ is calculated.

This t₆ is a computation result of a₁−a₂ and is expressed as indicated below.

t₆←a₁−a₂

In step S127, the second multiplication unit 125 performs a multiplication using t₅ and t₆. Specifically, the second multiplication unit 125 computes t₅t₆. By this, t₇ is calculated.

This t₇ is a computation result of t₅t₆ and is expressed as indicated below.

t₇←t₅t₆=(a₀+a₁)(a₁−a₂)

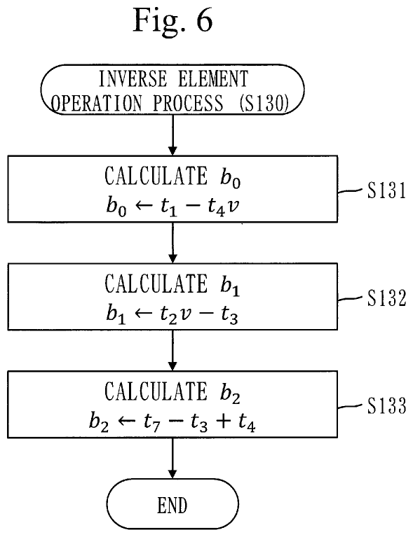

Based on FIG. 6, an inverse element operation process (S130) will be described.

In step S131, the first operation unit 131 performs a subtraction using t₁ and t₄.

Specifically, the first operation unit 131 multiplies t₄ by v to calculate t₄v. Then, the first operation unit 131 computes t₁−t₄v. “v” is a predetermined value.

By this, b₀ is calculated.

This b₀ is a computation result of t₁−t₄v and is expressed as indicated below.

b₀←t₁−t₄v=a₀²−a₁a₂v

In step S132, the second operation unit 132 performs a subtraction using t₂ and t₃.

Specifically, the second operation unit 132 multiplies t₂ by v to calculate t₂v. Then, the second operation unit 132 computes t₂v−t₃.

By this, b₁ is calculated.

This b₁ is a computation result of t₂v−t₃ and is expressed as indicated below.

b₁←t₂v−t₃=a₂²v−a₀a₁

In step S133, the third operation unit 133 performs an addition and a subtraction using t₃, t₄, and t₇. Specifically, the third operation unit 133 computes t₇−t₃+t₄. By this, b₂ is calculated.

This b₂ is a computation result of t₇−t₃+t₄ and is expressed as indicated below.

$$\begin{matrix}{b}_{2} ⟵ {t}_{7} - {t}_{3} + {t}_{4} = ( {a}_{0} + {a}_{1} ) ( {a}_{1} - {a}_{2} ) - {a}_{0} {a}_{1} + {a}_{1} {a}_{2} \\ = {a}_{0} {a}_{1} - {a}_{0} {a}_{2} + {a}_{1}^{2} - {a}_{1} {a}_{2} - {a}_{0} {a}_{1} + {a}_{1} {a}_{2} \\ = {a}_{1}^{2} - {a}_{0} {a}_{2}\end{matrix}$$

*** Description of Effects of the First Embodiment ***

By the first embodiment, squarings on a finite field for calculating an inverse element a⁻¹ can be reduced from three times to twice. That is, an inverse element calculation can be speeded up. As a result, pairing-based cryptography can be made more efficient.

*** Supplement to the First Embodiment ***

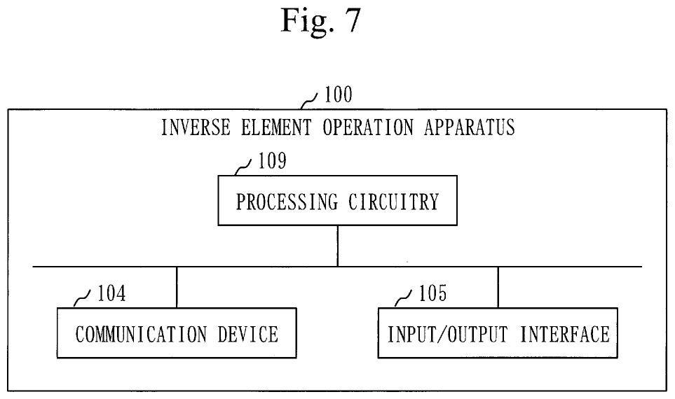

Based on FIG. 7, a hardware configuration of the inverse element operation apparatus 100 will be described.

The inverse element operation apparatus 100 includes processing circuitry 109.

The processing circuitry 109 is hardware that realizes the acceptance unit 110, the preliminary operation unit 120, the inverse element operation unit 130, and the output unit 140.

The processing circuitry 109 may be dedicated hardware, or may be the processor 101 that executes programs stored in the memory 102.

When the processing circuitry 109 is dedicated hardware, the processing circuitry 109 is, for example, a single circuit, a composite circuit, a programmed processor, a parallel-programmed processor, an ASIC, an FPGA, or a combination of these.

ASIC is an abbreviation for Application Specific Integrated Circuit.

FPGA is an abbreviation for Field Programmable Gate Array.

The inverse element operation apparatus 100 may include a plurality of processing circuits as an alternative to the processing circuitry 109.

In the processing circuitry 109, some functions may be realized by dedicated hardware, and the rest of the functions may be realized by software or firmware.

As described above, the functions of the inverse element operation apparatus 100 can be realized by hardware, software, firmware, or a combination of these.

### Second Embodiment

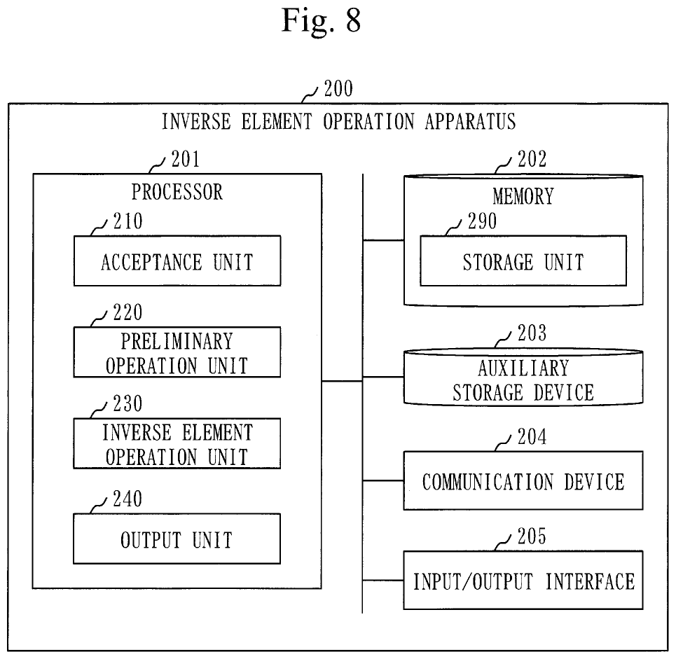

With regard to an embodiment in which an inverse element a¹ of an element a of a cyclotomic subgroup is calculated, differences from the first embodiment will be mainly described based on FIGS. 8 to 14.

*** Description of Configuration ***

Based on FIG. 8, a configuration of an inverse element operation apparatus 200 will be described.

The inverse element operation apparatus 200 is equivalent to the inverse element operation apparatus 100 in the first embodiment.

The inverse element operation apparatus 200 is a computer that includes hardware such as a processor 201, a memory 202, an auxiliary storage device 203, a communication device 204, and an input/output interface 205. These hardware components are connected with one another through signal lines.

The processor 201 is an IC that performs operational processing and controls other hardware components. For example, the processor 201 is a CPU.

The memory 202 is a volatile or non-volatile storage device. The memory 202 is also called a main storage device or a main memory. For example, the memory 202 is a RAM. Data stored in the memory 202 is saved in the auxiliary storage device 203 as necessary.

The auxiliary storage device 203 is anon-volatile storage device. For example, the auxiliary storage device 203 is a ROM, an HDD, or a flash memory. Data stored in the auxiliary storage device 203 is loaded into the memory 202 as necessary.

The communication device 204 is a receiver and a transmitter. For example, the communication device 204 is a communication chip or a NIC.

The input/output interface 205 is a port to which an input device and an output device are connected. For example, the input/output interface 205 is a USB terminal, the input device is a keyboard and a mouse, and the output device is a display.

The inverse element operation apparatus 200 includes elements such as an acceptance unit 210, a preliminary operation unit 220, an inverse element operation unit 230, and an output unit 240. These elements are realized by software.

The auxiliary storage device 203 stores an inverse element operation program to cause a computer to function as the acceptance unit 210, the preliminary operation unit 220, the inverse element operation unit 230, and the output unit 240. The inverse element operation program is loaded into the memory 202 and executed by the processor 201.

The auxiliary storage device 203 further stores an OS. At least part of the OS is loaded into the memory 202 and executed by the processor 201.

The processor 201 executes the inverse element operation program while executing the OS.

Input data and output data of the inverse element operation program are stored in a storage unit 290.

The memory 202 functions as the storage unit 290. However, a storage device such as the auxiliary storage device 203, a register in the processor 201, and a cache memory in the processor 201 may function as the storage unit 290 in place of the memory 202 or together with the memory 202.

The inverse element operation apparatus 200 may include a plurality of processors as an alternative to the processor 201.

The inverse element operation program can be recorded (stored) in a computer readable format in a non-volatile recording medium such as an optical disc or a flash memory.

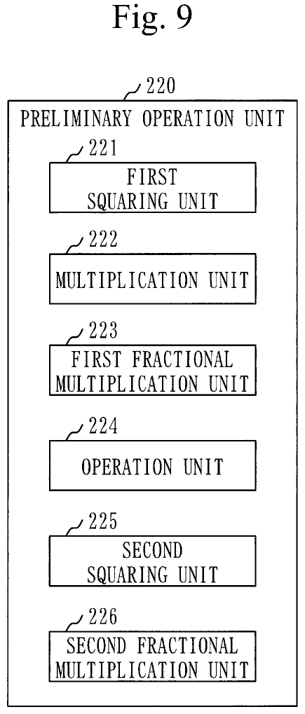

Based on FIG. 9, a configuration of the preliminary operation unit 220 will be described.

The preliminary operation unit 220 includes elements such as a first squaring unit 221, a multiplication unit 222, a first fractional multiplication unit 223, an operation unit 224, a second squaring unit 225, and a second fractional multiplication unit 226. The functions of these elements will be described later.

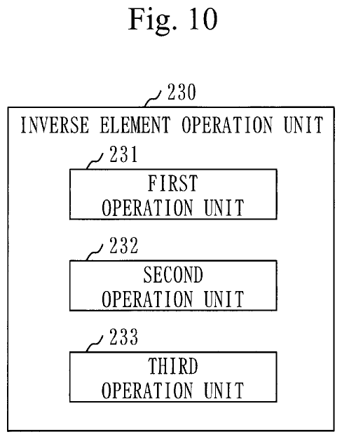

Based on FIG. 10, a configuration of the inverse element operation unit 230 will be described.

The inverse element operation unit 230 includes elements such as a first operation unit 231, a second operation unit 232, and a third operation unit 233. The functions of these elements will be described later.

*** Description of Preliminary Conditions ***

Preliminary conditions for an inverse element calculation by the inverse element operation apparatus 200 are the same as the preliminary conditions in the first embodiment.

*** Description of Operation ***

A procedure for operation of the inverse element operation apparatus 200 is equivalent to an inverse element operation method. The procedure for operation of the inverse element operation apparatus 200 is also equivalent to a procedure for processing by the inverse element operation program.

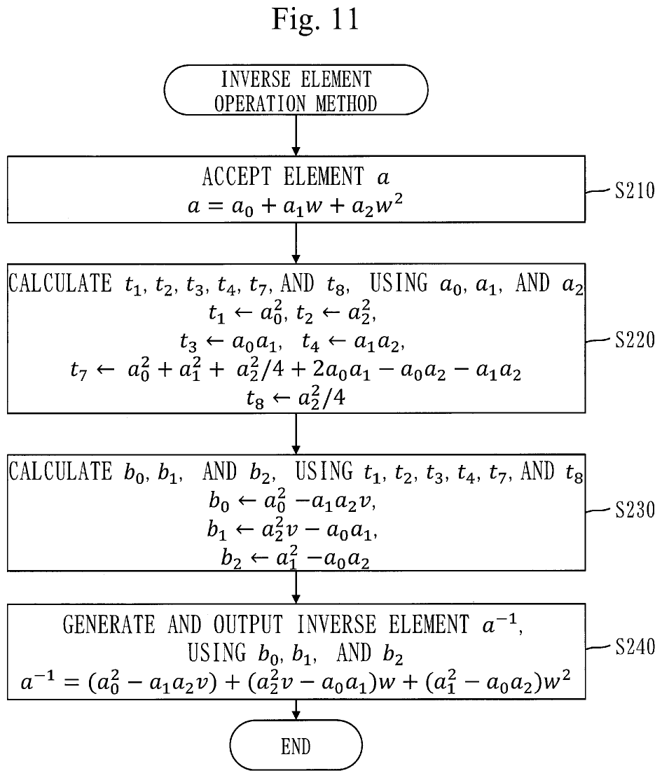

Based on FIG. 11, the inverse element operation method will be described.

In step S210, the acceptance unit 210 accepts an element a.

a=a₀+a₁w+a₂w²

Step S210 is the same as step S110 in the first embodiment.

In step S220, the preliminary operation unit 220 calculates t₁, t₂, t₃, t₄, t₇, and t₈, using a₀, a₁, and a₂, where

t₁ is a computation result of a₀²,

t₂ is a computation result of a₂²,

t₃ is a computation result of a₀a₁,

t₄ is a computation result of a₁a₂,

t₇ is equal to a computation result of a₀²+a₁²+a₂²/4+2a₀a₁−a₀a₂−a₁a₂, and

t₈ is equal to a computation result of a₂²/4.

Details of step S220 will be described later.

In step S230, the inverse element operation unit 230 calculates b₀, b₁, and b₂, using t₁, t₂, t₃, t₄, t₇, and t₈, where

b₀ is equal to a computation result of a₀²−a₁a₂v,

b₁ is equal to a computation result of a₂²v−a₀a₁, and

b₂ is equal to a computation result of a₁²−a₀a₂.

Details of step S230 will be described later.

In step S240, the output unit 140 outputs an inverse element a⁻¹.

a⁻¹=(a₀²−a₁a₂v)+(a₂²v−a₀a₁)w+(a₁²−a₀a₂)w²

Step S240 is the same as step S140 in the first embodiment.

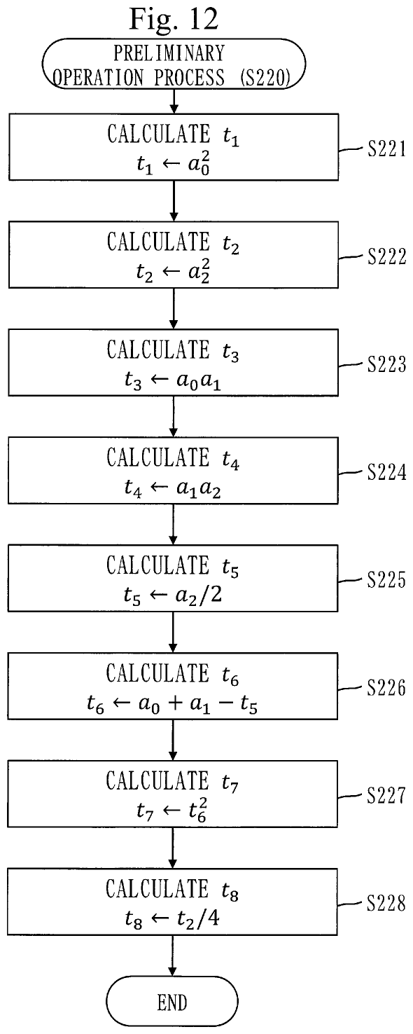

Based on FIG. 12, a preliminary operation process (S220) will be described.

In step S221, the first squaring unit 221 performs a squaring using a₀.

Specifically, the first squaring unit 221 computes a₀². By this, t₁ is calculated.

This t₁ is a computation result of a₀² and is expressed as indicated below.

t₁←a₀²

In step S222, the first squaring unit 221 performs a squaring using a₂. Specifically, the first squaring unit 221 computes a₂². By this, t₂ is calculated.

This t₂ is a computation result of a₂² and is expressed as indicated below.

t₂←a₂²

In step S223, the multiplication unit 222 performs a multiplication using a₀ and a₁. Specifically, the multiplication unit 222 computes a₀a₁. By this, t₃ is calculated.

This t₃ is a computation result of a₀a₁ and is expressed as indicated below.

t₃←a₀a₁

In step S224, the multiplication unit 222 performs a multiplication using a₁ and a₂. Specifically, the multiplication unit 222 computes a₁a₂. By this, t₄ is calculated.

This t₄ is a computation result of a₁a₂ and is expressed as indicated below.

t₄←a₁a₂

In step S225, the first fractional multiplication unit 223 performs a ½ multiplication using a₂. Specifically, the first fractional multiplication unit 223 computes a₂/2. By this, t₅ is calculated.

This t₅ is a computation result of a₂/2 and is expressed as indicated below.

t₅←a₂/2

In step S226, the operation unit 224 performs an addition and a subtraction using a₀, a₁, and t₅. Specifically, the operation unit 224 computes a₀+a₁−t₅. By this, t₆ is calculated.

This t₆ is a computation result of a₀+a₁−t₅ and is expressed as indicated below.

t₆←a₀+a₁−t₅=a₀+a₁−a₂/2

In step S227, the second squaring unit 225 performs a squaring using t₆. Specifically, the second squaring unit 225 computes t₆². By this, t₇ is calculated.

This t₇ is a computation result of t₆² and is expressed as indicated below.

$$\begin{matrix}{t}_{7} ⟵ {t}_{6}^{2} = {( {a}_{0} + {a}_{1} - {a}_{2} / 2 )}^{2} \\ = {a}_{0}^{2} + {a}_{0} {a}_{1} - {a}_{0} {a}_{2} / 2 + {a}_{0} {a}_{1} + {a}_{1}^{2} - {a}_{1} {a}_{2} / 2 - {a}_{1} {a}_{2} / 2 + {a}_{2}^{2} / 4 \\ = {a}_{0}^{2} + {a}_{1}^{2} + {a}_{2}^{2} / 4 + 2 {a}_{0} {a}_{1} - {a}_{0} {a}_{2} - {a}_{1} {a}_{2}\end{matrix}$$

In step S228, the second fractional multiplication unit 226 performs a ¼ multiplication using t₂. Specifically, the second fractional multiplication unit 226 computes t₂/4. By this, t₈ is calculated.

This t₈ is a computation result of t₂/4 and is expressed as indicated below.

t₈←t₂/4=a₂²/4

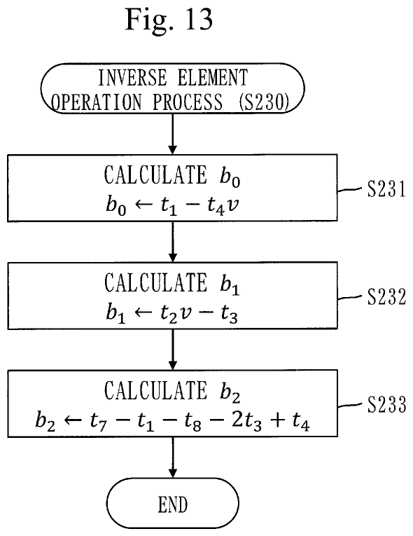

Based on FIG. 13, an inverse element operation process (S230) will be described.

In step S231, the first operation unit 231 performs a subtraction using t₁ and t₄.

Specifically, the first operation unit 131 multiplies t₄ by v to calculate t₄v. Then, the first operation unit 131 compute t₁−t₄v.

By this, b₀ is calculated.

This b₀ is a computation result of a₀²−a₁a₂v and is expressed as indicated below.

b₀←t₁−t₄v=a₀²−a₁a₂v

In step S232, the second operation unit 232 performs a subtraction using t₂ and t₃.

Specifically, the second operation unit 132 multiplies t₂ by v to calculate t₂v. Then, the second operation unit 132 computes t₂v−t₃.

By this, b₁ is calculated.

This b₁ is a computation result of t₂v−t₃ and is expressed as indicated below.

b₁←t₂v−t₃=a₂²v−a₀a₁

In step S233, the third operation unit 233 performs an addition and subtractions using t₁, t₃, t₄, t₇, and t₈. Specifically, the third operation unit 233 computes t₇−t₁−t₈−2t₃+t₄. By this, b₂ is calculated.

This b₂ is a computation result of t₇−t₁−t₈−2t₃+t₄ and is expressed as indicated below.

$$\begin{matrix}{b}_{2} ⟵ {t}_{7} - {t}_{1} - {t}_{8} - 2 {t}_{3} + {t}_{4} = {a}_{0}^{2} + {a}_{1}^{2} + {a}_{2}^{2} / 4 + 2 {a}_{0} {a}_{1} - {a}_{0} {a}_{2} - \\ {a}_{1} {a}_{2} - {a}_{0}^{2} - {a}_{2}^{2} / 4 - 2 {a}_{0} {a}_{1} + {a}_{1} {a}_{2} \\ = {a}_{1}^{2} - {a}_{0} {a}_{2}\end{matrix}$$

*** Effects of the Second Embodiment ***

By the second embodiment, multiplications on a finite field for calculating an inverse element a⁻¹ can be reduced from three times to twice. That is, an inverse element calculation can be speeded up. As a result, pairing-based cryptography can be made more efficient.

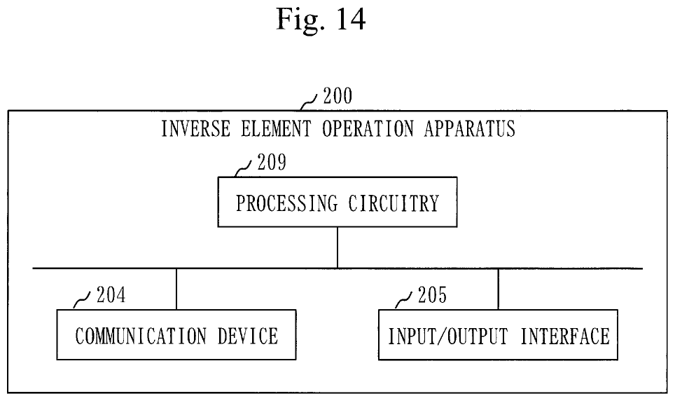

*** Supplement to the Second Embodiment *** Based on FIG. 14, a hardware configuration of the inverse element operation apparatus 200 will be described.

The inverse element operation apparatus 200 includes processing circuitry 209.

The processing circuitry 209 is hardware that realizes the acceptance unit 210, the preliminary operation unit 220, the inverse element operation unit 230, and the output unit 240.

The processing circuitry 209 may be dedicated hardware, or may be the processor 201 that executes programs stored in the memory 202.

When the processing circuitry 209 is dedicated hardware, the processing circuitry 209 is, for example, a single circuit, a composite circuit, a programmed processor, a parallel-programmed processor, an ASIC, an FPGA, or a combination of these.

The inverse element operation apparatus 200 may include a plurality of processing circuits as an alternative to the processing circuitry 209.

In the processing circuitry 209, some functions may be realized by dedicated hardware, and the rest of the functions may be realized by software or firmware.

As described above, the functions of the inverse element operation apparatus 200 can be realized by hardware, software, firmware, or a combination of these.

*** Supplement to the Embodiments ***

Each of the embodiments is an example of a preferred embodiment and is not intended to limit the technical scope of the present disclosure. Each of the embodiments may be implemented partially or may be implemented in combination with another embodiment. The procedures described using the flowcharts or the like may be changed as appropriate.

Each “unit” that is an element of the inverse element operation apparatus (100, 200) may be interpreted as “process” or “step”.

### REFERENCE SIGNS LIST

100: inverse element operation apparatus, 101: processor, 102: memory, 103: auxiliary storage device, 104: communication device, 105: input/output interface, 109: processing circuitry, 110: acceptance unit, 120: preliminary operation unit, 121: squaring unit, 122: first multiplication unit, 123: addition unit, 124: subtraction unit, 125: second multiplication unit, 130: inverse element operation unit, 131: first operation unit, 132: second operation unit, 133: third operation unit, 140: output unit, 190: storage unit, 200: inverse element operation apparatus, 201: processor, 202: memory, 203: auxiliary storage device, 204: communication device, 205: input/output interface, 209: processing circuitry, 210: acceptance unit, 220: preliminary operation unit, 221: first squaring unit, 222: multiplication unit, 223: first fractional multiplication unit, 224: operation unit, 225: second squaring unit, 226: second fractional multiplication unit, 230: inverse element operation unit, 231: first operation unit, 232: second operation unit, 233: third operation unit, 240: output unit, 290: storage unit.

1. An inverse element operation apparatus to calculate an inverse element a⁻¹ of an element a,
the element a being expressed by a=a₀+a₁w+a₂w²,
the inverse element a⁻¹ being expressed by a⁻¹=(a₀²−a₁a₂v)+(a₂²v−a₀a₁)w+(a₁²−a₀a₂)w²,
the inverse element operation apparatus comprising
processing circuitry to:
accept the element a;
calculate t₁ that is a computation result of a₀², t₂ that is a computation result of a₂², t₃ that is a computation result of a₀a₁, t₄ that is a computation result of a₁a₂, and t₇ that is equal to a computation result of (a₀+a₁)(a₁−a₂), using a₀, a₁, and a₂;
calculate b₀ that is equal to a computation result of a₀²−a₁a₂v, b₁ that is equal to a computation result of a₂²v−a₀a₁, and b₂ that is equal to a computation result of a₁²−a₀a₂, using t₁, t₂, t₃, t₄, and t₇; and
generate and output the inverse element a⁻¹, using b₀, b₁, and b₂.

2. The inverse element operation apparatus according to claim 1,
wherein the processing circuitry performs a squaring using a₀ to calculate t₁ that is the computation result of a₀², performs a squaring using a₂ to calculate t₂ that is the computation result of a₂²,
performs a multiplication using a₀ and a₁ to calculate t₃ that is the computation result of a₀a₁, performs a multiplication using a₁ and a₂ to calculate t₄ that is the computation result of a₁a₂,
performs an addition using a₀ and a₁ to calculate t₅ that is a computation result of a₀+a₁,
performs a subtraction using a₁ and a₂ to calculate t₆ that is a computation result of a₁−a₂, and
performs a multiplication using t₅ and t₆ to calculate t₇ that is equal to the computation result of (a₀+a₁)(a₁−a₂).

3. The inverse element operation apparatus according to claim 2,
wherein the processing circuitry calculates t₇ by computing t₅t₆.

4. The inverse element operation apparatus according to claim 1,
wherein the processing circuitry performs a subtraction using t₁ and t₄ to calculate b₀ that is equal to the computation result of a₀²−a₁a₂v,
performs a subtraction using t₂ and t₃ to calculate b₁ that is equal to the computation result of a₂²v−a₀a₁, and
performs an addition and a subtraction using t₃, t₄, and t₇ to calculate b₂ that is equal to the computation result of a₁²−a₀a₂.

5. The inverse element operation apparatus according to claim 4,
wherein the processing circuitry calculates b₀ by computing t₁−t₄v,
calculates b₁ by computing t₂v−t₃, and
calculates b₂ by computing t₇−t₃+t₄.

6. A non-transitory computer readable medium storing an inverse element operation program to calculate an inverse element a⁻¹ of an element a,
the element a being expressed by a=a₀+a₁w+a₂w²,
the inverse element a⁻¹ being expressed by a⁻¹=(a₀²−a₁a₂v)+(a₂²v−a₀a₁)w+(a₁²−a₀a₂)w²,
the inverse element operation program causing a computer to execute:
an acceptance process of accepting the element a;
a preliminary operation process of calculating t₁ that is a computation result of a₀², t₂ that is a computation result of a₂², t₃ that is a computation result of a₀a₁, t₄ that is a computation result of a₁a₂, and t₇ that is equal to a computation result of (a₀+a₁)(a₁−a₂), using a₀, a₁, and a₂;
an inverse element operation process of calculating b₀ that is equal to a computation result of a₀²−a₁a₂v, b₁ that is equal to a computation result of a₂²v−a₀a₁, and b₂ that is equal to a computation result of a₁²−a₀a₂, using t₁, t₂, t₃, t₄, and t₇; and
an output process of generating and outputting the inverse element a⁻¹, using b₀, b₁, and b₂.

7. An inverse element operation apparatus to calculate an inverse element a⁻¹ of an element a,
the element a being expressed by a=a₀+a₁w+a₂w²,
the inverse element a⁻¹ being expressed by a⁻¹=(a₀²−a₁a₂v)+(a₂²v−a₀a₁)w+(a₁²−a₀a₂)w²,
the inverse element operation apparatus comprising
processing circuitry to:
accept the element a;
calculate t₁ that is a computation result of a₀², t₂ that is a computation result of a₂², t₃ that is a computation result of a₀a₁, t₄ that is a computation result of a₁a₂, t₇ that is equal to a computation result of a₀²+a₁²+a₂²/4+2a₀a₁−a₀a₂−a₁a₂, and Is that is equal to a computation result of a₂²/4, using a₀, a₁, and a₂;
calculate b₀ that is equal to a computation result of a₀²−a₁a₂v, b₁ that is equal to a computation result of a₂²v−a₀a₁, and b₂ that is equal to a computation result of a₁²−a₀a₂, using t₁, t₂, t₃, t₄, t₇, and t₈; and
generate and output the inverse element a⁻¹, using b₀, b₁, and b₂.

8. The inverse element operation apparatus according to claim 7,
wherein the processing circuitry performs a squaring using a₀ to calculate t₁ that is the computation result of a₀², performs a squaring using a₂ to calculate t₂ that is the computation result of a₂²,
performs a multiplication using a₀ and a₁ to calculate t₃ that is the computation result of a₀a₁, performs a multiplication using a₁ and a₂ to calculate t₄ that is the computation result of a₁a₂,
performs a ½ multiplication using a₂ to calculate t₅ that is a computation result of a₂/2,
performs an addition and a subtraction using a₀, a₁, and t₅ to calculate t₆ that is equal to a computation result of a₀+a₁−a₂/2,
performs a squaring using t₆ to calculate t₇ that is equal to the computation result of a₀²+a₁²+a₂²/4+2a₀a₁−a₀a₂−a₁a₂, and
performs a ¼ multiplication using t₂ to calculate t₈ that is equal to the computation result of a₂²/4.

9. The inverse element operation apparatus according to claim 8,
wherein the processing circuitry calculates t₆ by computing a₀+a₁−t₅,
calculates t₇ by computing t₆², and
calculates t₈ by computing t₂/4.

10. The inverse element operation apparatus according to claim 7,
wherein the processing circuitry performs a subtraction using t₁ and t₄ to calculate b₀ that is equal to the computation result of a₀²−a₁a₂v,
performs a subtraction using t₂ and t₃ to calculate b₁ that is equal to the computation result of a₂²v−a₀a₁, and
performs an addition and a subtraction using t₁, t₃, t₄, t₇, and t₈ to calculate b₂ that is equal to the computation result of a₁²−a₀a₂.

11. The inverse element operation apparatus according to claim 10,
wherein the processing circuitry calculates b₀ by computing t₁−t₄v,
calculates b₁ by computing t₂v−t₃, and
calculates b₂ by computing t₇−t₁−t₈−2t₃−t₄.

12. A non-transitory computer readable medium storing an inverse element operation program to calculate an inverse element a⁻¹ of an element a,
the element a being expressed by a=a₀+a₁w+a₂w²,
the inverse element a⁻¹ being expressed by a⁻¹=(a₀²−a₁a₂v)+(a₂²v−a₀a₁)w+(a₁²−a₀a₂)w²,
the inverse element operation program causing a computer to execute:
an acceptance process of accepting the element a;
a preliminary operation process of calculating t₁ that is a computation result of a₀², t₂ that is a computation result of a₂², t₃ that is a computation result of a₀a₁, t₄ that is a computation result of a₁a₂, t₇ that is equal to a computation result of a₀²+a₁²+a₂²/4+2a₀a₁−a₀a₂−a₁a₂, and t₈ that is equal to a computation result of a₂²/4, using a₀, a₁, and a₂;
an inverse element operation process of calculating b₀ that is equal to a computation result of a₀²−a₁a₂v, b₁ that is equal to a computation result of a₂²v−a₀a₁, and b₂ that is equal to a computation result of a₁²−a₀a₂, using t₁, t₂, t₃, t₄, t₇, and t₈; and
an output process of generating and outputting the inverse element a⁻¹, using b₀, b₁, and b₂.
